(19) United States
(12) Patent Application Publication
(10) Pub. No.: US 2026/0126845 A1
(43) Pub. Date: May 7, 2026

(54) DYNAMIC POWER MANAGEMENT IN TIME RECORDING SYSTEM

(71) Applicant: William A. Horan, West Hempstead, NY (US)

(72) Inventor: William A. Horan, West Hempstead, NY (US)

(73) Assignee: GROUPCLOCK INC., Franklin Square, NY (US)

(21) Appl. No.: 19/376,945

(22) Filed: Nov. 1, 2025

Related U.S. Application Data
(60) Provisional application No. 63/715,324, filed on Nov. 1, 2024.

(51) Int. Cl. G06F 1/3228

(52) U.S. Cl. CPC G06F 1/3228

(57) ABSTRACT

A camera-based time recording system processes a video stream at a first processing setting to detect initiation of a time recording action. In response, the system adjusts to a second processing setting by at least one of increasing frame rate, processing more frames per unit time, increasing resolution, increasing computational capacity, and activating supplemental lighting. The system maintains the second setting for a timeout interval and reverts to the first setting absent further actions.

### CROSS-REFERENCE TO RELATED APPLICATIONS

This application claims the benefit of U.S. Provisional Application No. 63/715,324, filed on 1 Nov. 2024, which is incorporated in its entirety by this reference.

### TECHNICAL FIELD

The present invention relates to electronic time recording systems and methods for monitoring a designated space to detect user interactions, and more particularly to techniques for dynamically adjusting processing settings—such as frame rate, nth-frame selection, resolution, computational capacity, and lighting—upon initiation of a time recording action to optimize power consumption and operational performance.

### BACKGROUND

Time recording systems are deployed in workplaces, educational institutions, secure facilities, and other environments to capture attendance, manage access, and track task transitions. Such systems may use cameras or other scene-capturing devices to monitor a designated time recording space for user interactions (e.g., clock-in/clock-out events, break registration, or task changes).

In many deployments, capture and processing are configured for worst-case responsiveness—for example, operating at elevated frame rates and resolutions and allocating substantial computational resources on a continuous basis. While this configuration can support accurate detection and identification, maintaining high settings during extended idle intervals can increase energy use and compute load that provides limited benefit when user activity is low.

Sustained high-performance operation may also contribute to thermal and mechanical stress on components and can complicate scalability across multiple monitoring points, particularly where devices are battery-powered, installed in remote locations, or subject to power and heat constraints. As the number of monitored areas grows, cumulative power and resource demands can become a limiting factor.

Accordingly, there is a need for approaches that preserve responsiveness and accuracy during user interactions while reducing power consumption and computational workload during periods of low or no activity. In particular, techniques that adjust device-level and processing-stage settings in response to the initiation of a time recording action, and that revert automatically after inactivity, can improve overall efficiency without sacrificing performance.

### SUMMARY OF THE INVENTION

The present disclosure addresses the foregoing challenges by providing methods and systems for dynamically managing power and processing resources in camera-based time recording. In some embodiments, a video stream from a time recording space is processed at a first processing setting (e.g., reduced frame handling and/or simplified algorithms) to detect initiation of a time recording action. In response to initiation, the system transitions to a second processing setting by performing one or more of: increasing camera frame rate, increasing image resolution, processing more frames per unit time (e.g., decreasing an nth-frame parameter), allocating additional computational capacity (e.g., raising processor clock and/or activating additional cores), and switching to a more complex recognition model. In certain implementations, supplemental lighting may be activated or increased to improve capture quality during the active interval. Unlike approaches that escalate for general motion, the disclosed system transitions based on initiation of a time-recording action, reducing unnecessary ramp-ups while preserving responsiveness.

The system maintains the second processing setting for a timeout interval (T) and then reverts to the first processing setting absent further initiation. This approach conserves energy and compute during low-activity periods while applying higher-fidelity capture and analysis only when needed, thereby improving overall efficiency and extending hardware longevity without sacrificing responsiveness or accuracy.

The dynamic operation is scalable across multiple monitoring points and diverse deployment conditions, including battery-powered or remote installations. By keeping each unit efficient during idle intervals and elevating settings selectively during active intervals, aggregate power and resource demands are reduced compared to systems that operate at constant peak settings, facilitating cost-effective expansion to larger installations.

In some embodiments, multiple users (e.g., employees, time-recording entities) may perform time recording actions concurrently within the monitored space. The system can associate actions with respective users and process them in parallel, for example by maintaining per-user processing state during the active interval.

A time recording action can include any pose or gesture that the system is configured and/or trained to recognize as indicating an intent to record time. Examples include a hand raised above a shoulder line or above the head. The system can perform biometric recognition (e.g., facial recognition) to identify the user and record a transaction, and such recognition may occur before or after the time recording action, depending on implementation.

In some embodiments, a time recording action may comprise an elbow raised above a shoulder line or other defined pose/gesture. Upon detecting such an action, the system may perform the biometric recognition noted above and complete the time recording transaction.

The transaction record may include a unique user identifier (e.g., a number) and the time at which the time recording action was performed. It may also include other information, including but not limited to a location identifier, department identifier, job identifier, and/or a transaction-type identifier (also referred to as a time recording activity or time recording event). A time recording activity may include, without limitation, identifiers for clock-in (start of shift), clock-out (end of shift), out for lunch, in from lunch, out for break, and in from break. As used herein, a time recording activity may include any action detected by the system that relates to time management. This can encompass classified time recording activities (e.g., “clock-in,” “clock-out”) as well as unclassified time recording activities that are logged without immediate classification and later interpreted or classified based on timestamp, context, or other data-processing rules. The later interpretation may be performed by this system or by an external or third-party system.

### BRIEF DESCRIPTION OF THE FIGURES

FIG. 1 illustrates a schematic representation of a system 100 in accordance with one or more embodiments of the present application;

FIG. 2 illustrates an example method 200 in accordance with one or more embodiments of the present application; and

FIG. 3 illustrates an example schematic for evaluating time recording activities performed by a plurality of bodies identified in a time recording data stream in accordance with one or more embodiments of the present application.

### DESCRIPTION OF THE PREFERRED EMBODIMENTS

The following description of the preferred embodiments of the inventions are not intended to limit the inventions to these preferred embodiments, but rather to enable any person skilled in the art to make and use these inventions.

### 1. System for Automated Electronic Time Recording

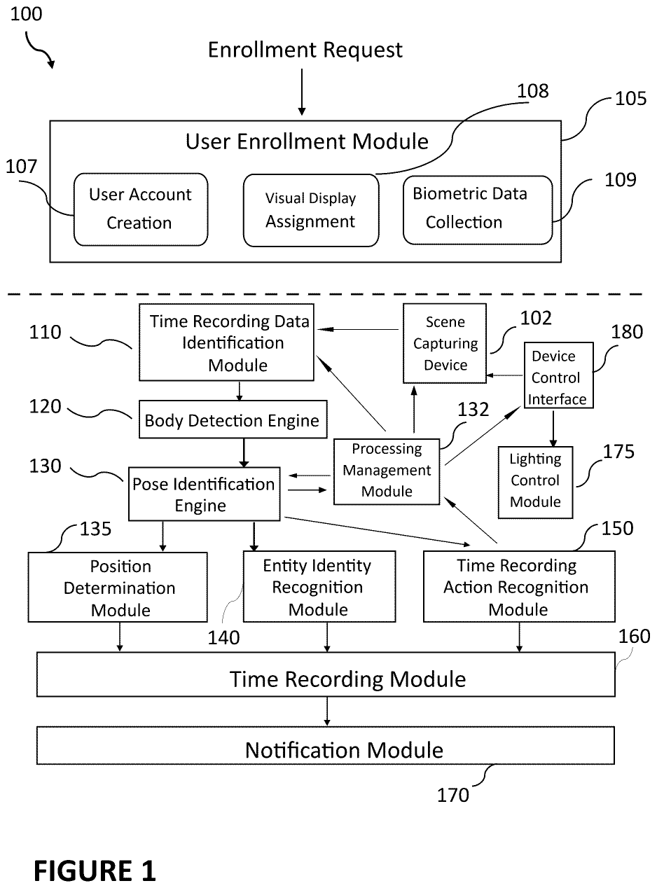

As shown in FIG. 1, a system 100 for automated electronic time recording may include a user enrollment module 105, a scene capturing device or devices 102, a time recording data identification module 110, a body detection engine 120, a pose identification engine 130, a processing management module 132, an entity identification recognition module 140, a time recording action recognition module 150, a time recording module 160, a notification module 170, a lighting control module 175, and a device control interface 180. In some embodiments, the user enrollment module 105, as shown in FIG. 1, may include a user account creation module 107, a visual display assignment module 108, and a biometric data collection module 109. Additionally, as shown in FIG. 1, the system 100 may optionally include a position determination module 135. Any of these modules or engines may run on one or more computers where the one or more computers may contain one or more processors. In various embodiments, one or more of the foregoing modules execute on-device (e.g., within a camera), on an edge gateway or on-premises server, in a cloud computing environment, or across a combination thereof. The system may obtain the video stream from remote scene-capturing device(s) 102 over a network and may transmit device-level commands over the network to configure camera frame rate and/or resolution, set n for module 110, and control lighting module 175. Device-level commands may be conveyed via the device-control interface 180 when present, or via an integrated control interface within module 132. Unless stated otherwise, module location and network topology are non-limiting; functionality may be partitioned, migrated, or mirrored among endpoints to satisfy latency, availability, or scaling objectives.

### 1.05 User Enrollment Module

The user enrollment module 105 may function to receive a request to enroll a target user to the system 100 (“enrollment request”). The enrollment request received by the user enrollment module 105 may have been initiated/triggered by the target user or on behalf of the target user (e.g., via an administrator of the system 100). In some embodiments, in response to the user enrollment module 105 receiving the request to enroll the target user to the system 100, the user enrollment module 105 may execute the user account creation module 107 and/or the visual display assignment module 108 and/or the biometric data collection module 109, which will now be described.

It shall be noted that the user enrollment module 105 may function to receive a plurality of requests for enrolling a plurality of target users to the system 100, and in such cases, the user enrollment module 105 may function to process the plurality of requests sequentially or concurrently.

### 1.07 User Account Creation Module

The user account creation module 107 may function to create a user account for the target user. That is, the user account creation module 107 may function to create a user account for the target user associated with the enrollment request received by the user enrollment module 105.

Creating the user account for the target user may include collecting information associated with the target user, such as a name of the target user, an address of the target user, a profile photo of the target user, and/or the like.

Creating the user account for the target user may also include creating or assigning a unique identifier to the target user. This unique identifier assigned to or created for the target user may be used, by the system 100, to delineate time recording activities performed by the target user from time recording activities performed by other users of the system 100. It shall be noted that after the user account creation module 107 creates a user account for the target user, the target user may then be able to interact with and/or access user interfaces provided by the system 100. The unique identifier for each user may be assigned either before, during, or after the biometric data collection. In cases where the biometric data is collected first, the system is configured to associate the biometric data with a unique identifier once it has been created, ensuring proper identification and linking of user information for subsequent time recording activities.

### 1.08 Visual Display Assignment Module

The visual display assignment module 108 may be configured to assign a user's notification data to a specific electronic visual display within the notification module 170, to a specific column or row on that display, and, optionally, to a specific appearance attribute such as color, selected from a plurality of colors, in which the user's notification data may appear when the system recognizes the user has performed a time recording action, as determined by the time recording module 160. In a preferred embodiment, each visual display would have at least two columns or two rows. If no specific color is assigned, then the notification data will appear in a default color where the default color is predetermined by the system or configured by an administrator. The visual display assignment module may also maintain a dynamic record of previous assignments, updating as new users are enrolled or removed from the system. Multiple users'notification data may share the same column or row on the same display and the same color. To automate the placement and appearance of notification data, the visual display assignment module 108 may implement an assignment algorithm, running on one or more computers, or another suitable process. This assignment algorithm may randomly assign users'notification data to a display, column or row, and optionally, color, without regard to specific rules or patterns, thereby creating a randomized distribution of notification data across available displays, columns, rows, and colors. Alternatively, the assignment algorithm may be used to achieve a balanced distribution of users'notification data. A balanced distribution is defined as the system attempting to assign an equal number of users'notification data to each display, an equal number of users'notification data to each column or each row, and, where multiple colors are used, an equal number of users'notification data to each color within each column or row on the available displays. The goal is to avoid visual clustering, ensuring clarity and visibility of users'activities on the display. The notification data assigned to users may include their first name, last name, unique identifier, and the time and date of the time recording action. Additionally, the notification data may include information about the time recording activities detected by the time recording action recognition module 150.

### 1.09 Biometric Data Collection Module

The biometric data collection module 109 may function to collect biometric data corresponding to the target user. The biometric data collected by the biometric data collection module 109 may include data used for constructing a facial signature of the target user, a vocal/voice signature of the target user, a gait (e.g., stride) signature of the target user, and/or the like.

In a preferred embodiment, the biometric data collection module 109 may be installed to an electronic device associated with the target user (e.g., a mobile application). In such embodiments, the biometric data collection module 109 may function to provide the target user with instructions for capturing the required biometric data and/or interface with one or more hardware components of the electronic device to capture the required biometric data of the target user.

Additionally, or alternatively, the biometric collection module 109 may be installed to one or more administrative systems and/or computing devices. In such embodiments, the biometric data collection module 109 (or similar enrollment module) may enable an administrator to collection biometric data of one or more users (e.g., employees and/or the like) of the system 100. In one or more embodiments, the biometric data collection module 109, as implemented for an administrator, may be in operable communication with one or more of a biometric data capturing device (e.g., cameras, bio scanners, and/or the like), a storage system, a time recording application (for creating a unique identifier), and/or the like.

### 1.10 Time Recording Data Identification Module

The time recording data identification module 110 may function to identify a time recording data stream. The time recording data stream identified by the time recording data identification module 110 may have been captured via one or more cameras (scene capturing device(s) 102) of the system 100 and/or captured via one or more cameras in communication with the system 100. The one or more cameras of the system 100 or the one or more cameras in communication with the system 100 may be referred to herein as “scene capturing device(s) 102.”

Preferably, the time recording data stream includes a plurality of frames or images that correspond to past, current, and/or recent activity occurring in a designated time recording space, such as a parking lot, hallway, room, or a factory floor of a facility. Accordingly, in such embodiments, one or more frames or images of the time recording data stream may include one or more representations of one or more bodies moving through the time recording scene with no intention of interacting with system 100, one or more representations of one or more stationary bodies performing time recording activities in the designated time recording space, and/or one or more representations of one or more bodies moving (e.g., walking, running, etc.) through the designated time recording space while performing a time recording activity. The time recording data identification module 110 may be configured to process all the frames identified in the data stream or may be configured to process every nth frame identified.

It shall be noted that the time recording data stream identified by the time recording data identification module 110 may have been captured via other types of scene capturing devices 102, including, but not limited to, LIDAR sensors, infrared sensors, microphones, and/or thermographic sensors.

### 1.20 Body Detection Engine

The body detection engine 120 may function to receive the time recording data stream identified by the time recording data identification module 110 and detect if one or more bodies exist in the time recording data stream. To detect if one or more bodies exist in the received time recording data stream, the body detection engine 120 may preferably implement a body detection algorithm that includes human body edge detection capabilities.

In addition, or as an alternative, to the above-described body detection algorithm, the body detection engine 120 may implement any other suitable human body detection process or algorithm for identifying if one or more bodies exist within the received time recording data stream. It shall be noted that, in some cases, when the body detection engine 120 detects a plurality of bodies in the time recording data stream, the system 100 may function to instantiate and execute one or more of the modules 130-170 for each of the plurality of bodies such that time recording activities potentially performed by each of the plurality of bodies can be detected in parallel (as opposed to detected sequentially).

### 1.30 Pose Identification Engine

The pose identification engine 130 may function to identify a pose for one or more of the bodies identified in the time recording data stream. In some embodiments, to detect a pose for one or more of the bodies identified in the time recording data stream, the pose identification engine 130 may preferably implement a pose detection model. The pose detection model may function to receive an image of a respective body as input and, in turn, detect one or more body parts captured in the provided image of the respective body and/or determine a position or location of the one or more detected body parts (e.g., X, Y, and/or Z coordinates).

Based on the computed positions of one or more of the detected body parts, the pose identification engine may function to evaluate/determine if the respective body satisfies time recording pose criteria. It shall be noted that in addition, or as an alternative, to the pose detection model, the pose identification engine 130 may implement any other suitable pose detection process or algorithm for identifying a pose for the one or more of the bodies identified in the time recording data stream.

### 1.32 Processing Management Module

The processing management module 132 functions as the coordination point for dynamic operation of the time recording system. Module 132 may receive a notification from the pose identification engine 130 that a pose satisfying time-recording pose criteria (i.e., a time recording action) has been detected, and/or a notification from the time recording action recognition module 150 that a specific gesture correlating to a time-recording activity has been recognized. In response, 132 determines one or more of the following adjustments to device-level settings (e.g., camera frame rate/resolution, supplemental lighting, compute power management) and module-level settings (e.g., nth-frame selection in 110) for a limited active interval and then reversion to idle.

In some embodiments, 132 communicates device-level commands via a device-control interface 180 to one or more endpoints (e.g., scene capturing device(s) 102 for frame-rate and resolution, lighting control module 175 for activation/intensity, and compute power-management endpoints for processor clocks/cores, such as an OS DVFS controller or SoC power manager). In other embodiments, the functionality of interface 180 is implemented within 132 as an integrated control interface (e.g., drivers/services), and commands are issued directly without a distinct interface component. The choice of a separate or integrated interface is non-limiting and may vary by implementation.

Variable frame rate (device-level). In some embodiments, the time-recording data stream includes a video stream captured by one or more cameras 102 operating initially at a first frame rate (first processing setting) selected to conserve power. Upon detecting a time recording action, 132 transmits a camera configuration command (via 180 or an integrated control interface of 132) to increase the frame rate to a second frame rate (second processing setting). The camera(s) may remain at the second frame rate for a timeout interval T and, if no subsequent time recording action is detected before T expires, revert to the first frame rate. For example, the first frame rate may be approximately 10 fps or less, and the second frame rate may be between 15 fps and 60 fps. In some implementations T is about 5 minutes; if a further time recording action is detected during T, T resets. These values are exemplary and not limiting.

Nth-frame selection (module-level). In some embodiments, the camera(s) operate at a constant frame rate (first processing setting), and the time recording data identification module 110 is configured to process every nth frame of the video stream at idle (n≥2). When a time recording action is detected, 132 sends a configuration command directly to 110 to decrease n so that more frames are processed per unit time (second processing setting). The second setting persists for T and then 110 reverts to the idle value of n absent further activity. For example, the camera(s) may operate at 30 fps while 110 processes every 6th frame at idle and every 2nd frame during the active interval of about 5 minutes (resetting if another time recording action is detected). These values are illustrative and may be varied.

Variable resolution (device-level). In some embodiments, system 100 dynamically adjusts image resolution to balance efficiency and recognition quality. Initially, the camera(s) 102 operate at a first resolution sufficient for coarse monitoring (e.g., 640×480 (VGA) or lower). When a time recording action is detected, 132 transmits a camera configuration command (via 180 or integrated control) to increase to a second resolution (e.g., 1280×720 (HD), 1920×1080 (Full HD), or higher). The camera(s) may maintain the second resolution for T and then revert to the first resolution if no additional actions are detected; T resets upon subsequent actions. The enumerated resolutions and duration are exemplary.

Supplemental lighting (device-level via 175). In some embodiments, the supplemental lighting is controlled to enhance capture quality during the active interval. Initially, lighting can be off or at a low level. Upon detecting a time recording action, 132 transmits a lighting control command to the lighting control module 175 (e.g., via 180 or integrated control within 132) to activate lighting or increase illumination. Improved lighting can enhance body/pose detection (130), identity recognition, and gesture recognition. Lighting remains elevated for T and then is turned off or returned to the prior level absent further activity; T resets if additional actions occur. Example durations and intensity levels are illustrative and non-limiting.

Compute scaling and model selection (device-/module-level). In some embodiments, during the second processing setting the system performs one or both of: (a) increasing computational capacity by raising a processor clock and/or activating additional processor cores (e.g., by issuing power-management commands via 180 to a hardware endpoint or via an integrated control path), and (b) transitioning from a first, lightweight machine-learning algorithm to a second, heavier algorithm with a higher parameter count. Each action may be taken independently; in some cases both are performed to meet latency or accuracy targets during the active interval. The heavier model is used during the active interval to improve recognition fidelity (e.g., detailed gestures or subtle pose variations), after which the system may revert to the lightweight model and may also revert to a lower compute state when T expires. The particular models, parameter counts, and power-management mechanisms are implementation-dependent and non-limiting.

Processing hardware. The one or more processors utilized in the time recording system 100 may include, without limitation, CPUs, GPUs, DSPs, ASICs, FPGAs, SoCs, or combinations thereof, located on a general-purpose computer, embedded platform, or integrated with camera hardware. In some embodiments, compute-intensive operations (e.g., inference) are offloaded to a GPU or hardware accelerator, while general tasks run on a CPU; in others, an ASIC or FPGA performs selected functions (e.g., real-time image processing). Dynamic frequency/voltage scaling and core activation/deactivation may be used to modulate computational capacity as described herein, with control issued by 132 either via device-control interface 180 or through an integrated control interface within 132. The invention is not limited to any particular processor or architecture.

### 1.33 Lighting Control Module

The lighting control module 175 receives lighting control commands and drives one or more luminaires (e.g., visible and/or IR LED arrays) that illuminate the time recording space. In some embodiments, 175 implements on/off and intensity control (e.g., PWM or constant-current dimming) and may provide status/telemetry (e.g., fault, temperature, current). 175 may be a discrete driver, a microcontroller board, or logic integrated into a camera housing. Lighting control module 175 controls illumination only and does not perform processor or core power management.

Lighting commands originate from processing management module 132 and may be conveyed via the device-control interface 180 or via an integrated control interface within 132 when 180 is not provided as a distinct component. Lighting is typically off/low in the first processing setting and activated and/or increased during the active interval to improve capture quality for pose detection, identity recognition, and gesture recognition; lighting reverts when the timeout T expires absent further actions, and detection of a further action during T resets T.

In some embodiments, 175 supports zonal or directional lighting (multiple channels aimed at different areas) and wavelength selection (e.g., IR/NIR illumination) to accommodate low-light operation without user distraction. The particulars of fixture type, placement, and driver electronics are implementation-dependent and non-limiting.

### 1.34 Device-Control Interface

The device-control interface 180 provides a command path from processing management module 132 to hardware endpoints, including scene-capturing device(s) 102 (e.g., frame rate and resolution configuration), lighting control module 175 (activation/intensity), and compute power-management endpoints (e.g., processor clock and core activation). Interface 180 is optional: in some embodiments it is a distinct hardware or software interface; in other embodiments its functionality is implemented within 132 (e.g., driver stack or services), and commands are issued directly without a separate interface component.

Interface 180 may be realized over wired and/or wireless links and can comprise one or more control channels, e.g., I²C, SPI, GPIO/PWM, RS-485, USB/UVC, USB3-Vision, Ethernet-based protocols (e.g., ONVIF/GenICam), Wi-Fi, or Bluetooth. In some implementations, 180 also conveys power-management commands to adjust processor clock frequency and core activation. Inter-module configuration that is not device-level—such as nth-frame selection in 110—may be signaled directly from 132 to the target module, or routed over 180 when the control plane is unified; in the latter case, 180 may represent a logical messaging interface (e.g., IPC or software bus) rather than a physical bus.

The presence or absence of 180 does not limit operation: any suitable arrangement that transmits the device-control commands disclosed herein can be used to transition between the first and second processing settings, maintain the second setting for T, and revert absent further time-recording actions.

### 1.35 Position Determination Module

The pose determination module 135 may function to receive, from the pose identification engine 130, the positions/locations of one or more body parts of the target body. In turn, the position determination module 135 may compare the positions/locations of the one or more body parts of the target body to known time recording zones located in the time recording space to determine the time recording zone in which the target body may be located. It shall be noted that in addition, or as an alternative, to the above description the position determination module 135 may function to determine a position/location of a target body in the time recording space via any other body position detection model.

### 1.40 Entity Identity Recognition Module

The entity identity recognition module 140 may function to detect an identity for one or more of the bodies detected in the time recording data stream. In some embodiments, to detect an identity associated with one or more of the bodies detected in the time recording data stream, the entity identity recognition module 140 may preferably implement an identity detection model. The identity detection model may function to receive a portion of a respective body as input (e.g., the head of the body) and derive an identity associated with the respective body as output, such as a name corresponding to the respective body, an identification number associated with the respective body (e.g., as described with respect to the user enrollment module 105), contact information associated with the body, and/or the like.

Additionally, or alternatively, to the embodiment described above, S230 may function to compare the portion of the respective body (e.g., the head of the body) to a database that includes stored facial images of potential users and/or facial image features (e.g., eyes, nose, ears, lips, chin, etc.) of the potential users to derive an identity of associated with the respective body.

### 1.50 Time Recording Action Recognition Module

The time recording action recognition module 150 may function to detect or recognize a time recording action (or gesture) performed by one or more of the bodies detected in the time recording data stream. In some embodiments, to detect the time recording action performed by one or more of the bodies detected in the time recording data stream, the time recording action recognition module 150 may function to implement a time recording action recognition algorithm or model. The input provided to the time recording action recognition algorithm may correspond to a portion of a respective body (e.g., an image of a hand) and provide a name of the time recording activity performed by the respective body as output and/or provide a corresponding time recording code as output.

Time recording activities that may be detected by the time recording action recognition module 150 may include hand gestures for registering for work (“clock-in”), hand gestures for finishing work (“clock-out”), hand gestures for changing current labor task (“task change/transfer”), hand gestures for registering for a break (“break start”), hand gestures for ending the break (“break end”), hand gestures for registering for a meal (“lunch start”), hand gestures for ending the meal (“lunch end”), and/or the like.

Additionally, or alternatively, each of the body detection engine 120 (e.g., pixellib or the like), pose identification engine 130 (e.g., mediapipe or the like), pose determination module 135, entity identity recognition module 140, time recording action recognition module 150 (e.g., mobilenet or the like) may implement one or more ensembles of trained machine learning models. In some embodiments, a single machine learning model or ensemble of models may be configured to perform multiple functions across these modules. For example, a unified model may simultaneously perform action recognition and user identification by processing shared features from the data stream. This integrated approach can improve processing efficiency and accuracy by leveraging common data representations and reducing computational redundancy. The one or more ensembles of machine learning models may employ any suitable machine learning including one or more of: supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), adversarial learning, and any other suitable learning style. Each module of the plurality can implement any one or more of: a machine learning classifier, computer vision model, convolutional neural network (e.g., ResNet), visual transformer model (e.g., ViT), object detection model (e.g., R-CNN, YOLO, etc.), regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a semantic image segmentation model, an image instance segmentation model, a panoptic segmentation model, a keypoint detection model, a person segmentation model, an image captioning model, a 3D reconstruction model, a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, density-based spatial clustering of applications with noise (DBSCAN), expectation maximization, etc.), a bidirectional encoder representation from transformers (BERT) for masked language model tasks and next sentence prediction tasks and the like, variations of BERT (i.e., ULMFiT, XLM UDify, MT-DNN, SpanBERT, RoBERTa, XLNet, ERNIE, KnowBERT, VideoBERT, ERNIE BERT-wwm, MobileBERT, TinyBERT, GPT, GPT-2, GPT-3, GPT-4 (and all subsequent iterations), ELMo, content2Vec, and the like), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial lest squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and any suitable form of machine learning algorithm. Each processing portion of the system 100 can additionally or alternatively leverage: a probabilistic module, heuristic module, deterministic module, or any other suitable module leveraging any other suitable computation method, machine learning method or combination thereof. For instance, a convolutional neural network may be designed to output both action recognition and user identification results from the same input data, utilizing shared layers and optimizing jointly for both tasks. However, any suitable machine learning approach can otherwise be incorporated in the system 100. Further, any suitable model (e.g., machine learning, non-machine learning, etc.) may be implemented in the various systems and/or methods described herein. It should also be noted that any of the methods or models (whether machine learning-based or non-machine learning) described in this section may be used not only for the tasks mentioned, such as body detection, pose identification, pose determination, entity identity recognition, and/or time recording action recognition, but also for assigning notification data to a display placement and/or appearance attribute(s). For example, one or more machine learning methods may perform all of these tasks, including the assignment of notification data. Furthermore, any of the methods or models may run on one or more computers, where any combination of methods or models—including a single method or model—can run on a single computer, on separate computers, or in any combination thereof.

### 1.60 Time Recording Module

The time recording module 160 may function to record time recording activities performed by one or more of the bodies detected in the time recording data stream to a time recording database of the system 100 or to a time recording database in communication with the system 100. To record or register a time recording activity performed by a body in the time recording data stream, the time recording module 160 may function to receive, as input, a pose identified by the pose identification engine 130, the time recording zone in which the body may be located from the position determination module 135, receive the user/identity associated with the body from the entity identity recognition module 140, and/or receive the time recording action performed by the body from the time recording action recognition module 150.

In response to the time recording module 160 receiving the above-described data (inputs), the time recording module 160 may function to construct and record a time recording entry to the time recording database. The time recording entry may include information indicating that, at a particular time, the user associated with the detected body performed a particular time recording activity while located within a particular time recording zone. It shall be noted that a time recording zone may not be required to be specified in order to record time to the time recording database.

Additionally, it shall also be noted that recording a time entry to the time recording database may cause a time recording state for the user associated with the time recording entry to be updated accordingly (e.g., change from being in a clocked-in state to being in a clocked-out state).

### 1.70 Notification Module

The notification module 170 may function to notify a target user when (or after) a time recording entry has been successfully registered for the target user. That is, in response to the time recording module 160 registering a time recording activity to a time recording database, or a time recording action being recognized by the system, the notification module 170 may function to display, via a display generation component of the system 100, a notification that indicates attributes or characteristics about the recently registered time recording activity. The system may communicate data to the display using any suitable wired or wireless communication method, including but not limited to HDMI, DisplayPort, USB-C, Ethernet, or wireless methods like Wi-Fi or Bluetooth. The notification data may be organized and displayed in a manner determined by the visual display assignment module 108. All notification data displayed on the electronic visual display(s) may be programmed to be removed after a predetermined amount of time elapses, which is either hard-coded or defined by an administrator, without a time recording action being recognized by the system. Alternatively, notification data may be programmed to be removed on a rolling basis, where each unique notification is removed after a predetermined amount of time elapses from its first appearance, this amount of time being either hard-coded or defined by an administrator. Notification data may be refreshed on the display in real-time or at a predetermined interval. The term “real-time” refers to updates to the electronic visual display that occur substantially immediately after the corresponding time recording action is recognized by the system, accounting for any minimal processing delays that may arise due to the system's operational constraints. Additionally, or alternatively, the notification module 170 may function to transmit, to an electronic device associated with the target user, a notification that indicates attributes or characteristics about the recently registered time recording activity. This notification may be communicated by electronic means, including but not limited to text message, email, or through a mobile, native, or web application.

In a preferred embodiment, when a time recording action is recognized by the system and the user is biometrically identified, the notification data for that user may be displayed at the top of a vertically oriented column. It may remain in that position until a new time recording action is successfully performed by another biometrically identified user whose notification data is assigned to the same column. At that time, the new notification data may appear at the top of said column, and the notification data from the previous user may shift down one row. As new notification data is displayed in the same column, all previous notification data within that same column may shift down one row accordingly. If the same user performs consecutive time recording actions without another biometrically identified user performing a time recording action in between, the notification data for that user may be displayed consecutively in the column, each entry retaining its originally assigned appearance attributes, such as color, font, font style, and font size, as it shifts downward. The notification data retains its originally assigned appearance attributes throughout this process, even if the notification data displayed has different attributes than the notification data in the position that it is moving into. This ensures that the notification data preserves its visual identity as it moves down the column, aiding in rapid user recognition. When the notification data reaches the bottom of the column and there is no longer space to display additional data, the oldest notification data at the bottom of the column may be removed from the display to make room for the new notification data at the top.

Additionally, or alternatively, when a time recording action is recognized by the system and the user is biometrically identified, the notification data for that user may be displayed at the beginning of a horizontally oriented row. It may remain in that position until a new time recording action is successfully performed by another biometrically identified user whose notification data is assigned to the same row. At that time, the new notification data may appear at the beginning of said row, and the notification data from the previous user may shift to the right, moving one position across the row. Alternatively, in some configurations, the notification data may shift to the left, depending on system preferences. As new notification data is displayed in the same row, all previous notification data within that same row may shift accordingly. If the same user performs consecutive time recording actions without another biometrically identified user performing a time recording action in between, the notification data for that user may be displayed consecutively in the row, each entry retaining its originally assigned appearance attributes, such as color, font, font style, and font size, as it shifts across the row. The notification data retains its originally assigned appearance attributes throughout this process, even if the notification data displayed has different attributes than the notification data in the position that it is moving into. This ensures that the notification data preserves its visual identity as it moves across the row, aiding in rapid user recognition. When the notification data reaches the end of the row and there is no longer space to display additional data, the oldest notification data at the far right (or left, depending on system configuration) of the row may be removed from the display to make room for the new notification data at the beginning of the row.

### 2. Method for Automated Electronic Time Recording

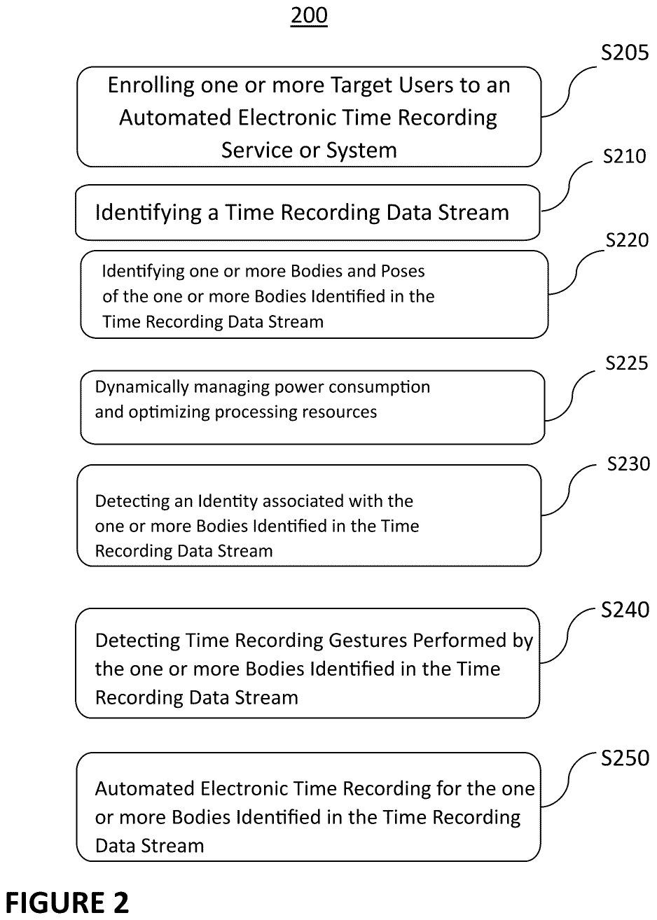

As shown in FIG. 2, the method 200 for automated electronic time recording may include enrolling one or more target users to an automated electronic time recording system or service (S205), identifying a time recording data stream (S210), identifying one or more bodies and poses of the one or more bodies in the time recording data stream (S220), dynamically managing power consumption and optimizing processing resources (S225), detecting an identity associated with the one or more bodies identified in the time recording data stream (S230), detecting time recording gestures performed by the one or more bodies identified in the time recording data stream (S240), and automated electronic time recording for the one or more bodies identified in the time recording data stream (S250). In various embodiments, one or more of the foregoing operations are performed by processors executing on-device, on an edge or on-premises server, in a cloud computing environment, or across a combination thereof.

### 2.05 User Enrollment|Biometric Data Collection

S205, which includes enrolling a target user, may function to enroll the target user to an automated electronic time recording system or service (e.g., system 100). Enrolling the target user to the automated electronic time recording service may include creating a user account for the target user and/or may include associating the created user account with biometric data corresponding to the target user. The user account created for the target user may enable the automated time recording service to receive time recording signals from the target user without requiring the target user to physically touch an input element of the automated electronic time recording service, as will be described in more detail herein.

### Creating a User Account

In one or more embodiments, creating a user account for the target user includes creating or assigning a unique identifier (e.g., User ID) to the target user. The unique identifier assigned to or created for the target user may be used, by the automated electronic time recording service, to delineate time recording activities performed by the target user from time recording activities performed by other users of the automated time recording service, as will be described in more detail in S250. In a first implementation, the unique identifier of the target user may be automatically created or generated by the automated electronic time recording service (e.g., not influenced by user provided input). Alternatively, in a second implementation, S205 may assign a unique identifier to the target user based on a user provided unique identifier or an administrator provided unique identifier (e.g., use a provided email address as the unique identifier, an alphanumeric value, number, and/or the like).

### Biometric Data

In one or more embodiments, S205 may also function to collect biometric data corresponding to the target user. The biometric data collected by S205 may include data used for constructing a facial signature of the target user, a vocal/voice signature of the target user, a gait (e.g., stride) signature of the target user, and/or the like. In a preferred embodiment, S205 may function to collect such biometric data via an (e.g., mobile) application provided by the automated electronic time recording service. In such embodiments, the application provided by the automated electronic time recording service may function to provide the target user with instructions for capturing the required biometric data (e.g., instructions for capturing one or more facial characteristics of the target user, one or more walking characteristics of the target user, one or more voice characteristics of the target user, and/or the like). Additionally, the application provided by the automated electronic time recording service may be installed on an electronic device associated with the target user and/or function to interface with one or more hardware components (e.g., a camera, microphone, biometric data-capturing device, fingerprint reader, and/or the like) of the electronic device to capture the required biometric data of the target user.

After collecting the biometric data corresponding to the target user, S205 may function to digitally associate or link the collected biometric data of the target user to the unique identifier assigned to/created for the target user (e.g., store biometric data and user identifier data in a suitable data structure, such as a data table, or the like). As will be described in more detail herein, digitally linking the biometric data of the target user to the unique identifier of the target user may enable the automated electronic time recording service to recognize, detect, and/or identify users interacting the automated electronic time recording service.

It shall be noted that while the above description describes examples of enrolling a single target user to the automated electronic time recording service, S205 may function to enroll a plurality of target users to the automated electronic time recording service in analogous ways described above.

### 2.10 Scene Identification

S210, which includes identifying a time recording data stream, may function to receive or capture a time recording data stream or one or more images or recordings of a scene that may include representations of one or more users enrolled in the automated electronic time recording service performing time recording gestures or actions. In some embodiments, the time recording data stream may additionally, or alternatively, include representations of one or more users that are not enrolled in the automated electronic time recording service and/or include representations of one or more users enrolled in the automated electronic time recording service that are not performing a respective time recording activity/gesture. It shall be noted that, for ease of description in some parts of the disclosure, a representation of a user in the time recording data stream may simply be referred to as “a user included in the time recording data stream.”

Time recording gestures, as generally referred to herein, may be air gestures that users can physically perform to record time activities to the automated electronic time recording service, such as air gestures to register for work (“clock-in”), air gestures to finish work (“clock-out”), air gestures to change current labor task (“task change/transfer”), air gestures to register for a break (“break start”), air gestures to end the break (“break end”), air gestures to register for a meal (“lunch start”), air gestures to end the meal (“lunch end”), and/or the like. Additionally, or alternatively, time recording gestures may correspond to implicit or non-specific time recording activities, which may also be referred to as unclassified time recording activities (e.g., air gestures used to record a new time activity/action to the automated electronic time recording service without explicitly specifying the time activity/action type). Additional details relating to the time recording gestures will be described in further detail at S240.

In a preferred embodiment, the time recording data stream may be a video stream captured via one or more video cameras (e.g., one or more scene capturing devices). The one or more video cameras may be installed in a physical location/facility associated with one or more target users (employees) and/or may be wide field-of-view cameras capable of capturing or recording physical activity of the one or more target users (employees) within a designated time recording space or scene (e.g., one or more hallways, one or more rooms, one or more factory floors of a physical facility associated with an employer, and/or the like). Accordingly, in one or more embodiments, the time recording data stream captured via the one or more video cameras may include representations of a plurality of users (employees) moving through the time recording scene with no intention of interacting with the automated electronic time recording service, representations of a plurality of stationary users (employees) performing time recording gestures in the time recording scene, representations of a plurality of users (employees) moving through the time recording scene while performing time recording gestures, and/or the like.

In some embodiments, the time recording scene includes distinct time recording zones or areas. These distinct time recording zones may correspond to distinct tasks with which a performed time recording gesture may be associated. For instance, if a first user performs a first time-recording gesture while located within a first time recording zone, the first time recording gesture may be intended to correspond to a first job task. Conversely, if the first user performs the first time recording gesture while located within a second time recording zone, the first time recording gesture may be intended to correspond to a second job task (different than the first job task). Accordingly, in such embodiments, the time recording data stream may include representations of the time reporting zones/areas located within the time reporting scene such that the automated electronic time recording service may gauge time recording intent of the one or more users in the time reporting space/scene.

Alternatively, the time recording data stream may not be captured via one or more video cameras, but rather captured via any other scene capturing device capable of capturing activity of one or more users within the time reporting scene (e.g., LIDAR sensors or cameras, infrared sensors or cameras, thermographic sensors or cameras, microphones, and/or the like).

### 2.20 Body & Pose Detection|Time Recording Intent

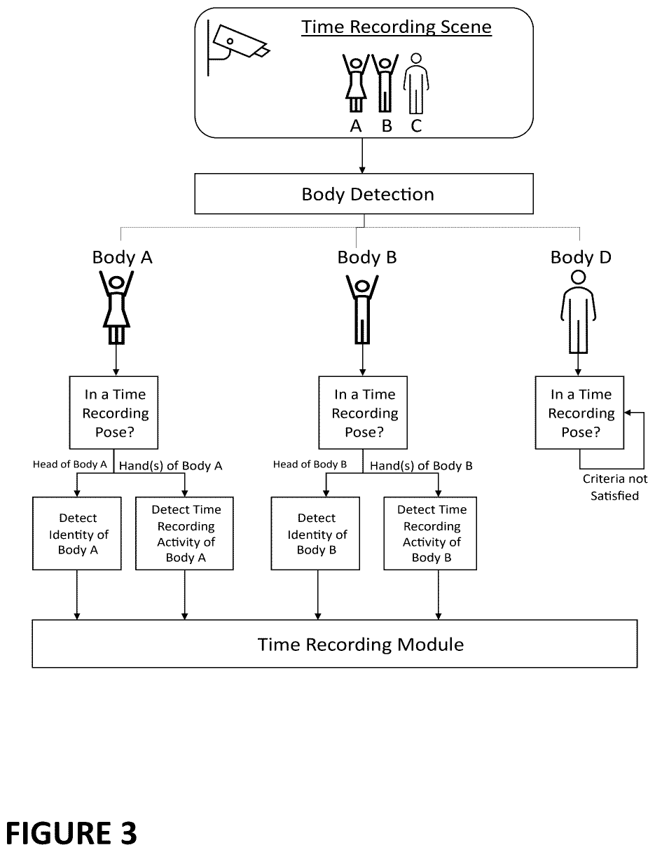

S220, which includes detecting bodies and poses, may function to detect if one or more bodies exist in the time recording data stream identified by S210 and/or detect if the one or more bodies captured in the time recording data stream satisfy time recording pose criteria. Additionally, or alternatively, S220 may function to trigger concurrent or parallel time recording processes for the one or more bodies detected in the time recording data stream, as generally illustrated in FIG. 3.

### Body Detection

In one or more embodiments, to determine if one or more bodies exist in the time recording data stream, S220 may function to implement a body detection algorithm/model. The body detection algorithm/model may function to identify human bodies existing in the time recording data stream and/or delineate the identified bodies from one another and/or other objects within a scene. In a preferred embodiment, to delineate the identified bodies in the time recording data stream from one another, the body detection model may apply a unique (e.g., color-coded) pixel mask to each identified body. Additionally, or alternatively, to delineate the distinct bodies identified in the time recording data stream from one another, the body detection model may individually encapsulate/bound each identified body (e.g., via distinct bounding boxes). It shall be noted that the body detection algorithm/model may also function to similarly identify/detect non-body related objects, which in turn, may eliminate false positive body detections in the time recording stream.

For instance, in a non-limiting example, the time recording data stream may include a plurality of frames (images) of the time recording scene. The body detection algorithm may receive a respective frame (e.g., representation) of the time recording data stream as input and produce a body-segmented image of the respective frame as output. If the time recording scene during the respective frame includes one or more bodies, the segmented image may uniquely mask or uniquely code each of the one or more bodies (e.g., a first body has a first pixel mask, a second body has a second pixel mask, etc.). Similarly, if the time recording scene during the respective frame includes one or more non-body objects (e.g., ceilings, walls, floors, furniture, and/or the like), the segmented image may generally, or uniquely, mask each of the one or more non-body objects as “nonbody” objects. Other frames of the time recording data stream may be processed by the body detection model in a similar manner as described above and throughout the embodiments of the present application.

### Pose Detection

In some embodiments, S220 may function to detect a pose for the one or more bodies identified in the time recording data stream. To detect a pose of a respective body in the time recording data stream, S220 may first function to generate or isolate an image of the respective body by extracting pixels from the time recording data stream corresponding to the respective body (e.g., the pixel mask corresponding to the respective body). Accordingly, the generated image of the respective body may only include a representation of that respective or singular body and may not include representations of other bodies and/or representations of non-body objects that may exist beyond a respective bounding box or respective outline of the target body. It shall be noted that, in cases in which the time recording data stream includes a plurality of bodies, S220 may function to concurrently generate and/or isolate images for the plurality of bodies (as opposed to generated sequentially in which one image of a body may be generated at a time).

Additionally, while or after generating images corresponding to the one or more bodies identified in the time recording data stream, S220 may also function to concurrently instantiate one or more instances of a pose detection model for each of the one or more bodies identified by the body detection model. Creating distinct instances of the pose detection model may allow poses of the one or more bodies in the time recording data stream to be computed in parallel (as opposed to computed sequentially in which poses of the one or more bodies may be determined one at a time). At least one technical benefit of such embodiment may be an accelerated detection and computation of bodies in a predetermined pose indicating a likely intent of a user to perform a time recording action or gesture. Thus, in such embodiments, a technical effect of accelerating a computing and/or detection by a computing system of whether a required pose and/or time recording gesture (as described below) has been achieved by entities in identified in a given scene. Further, in such embodiments, the technical effect of accelerated computing may be achieved based on the automatic instantiation of a plurality of distinct virtual machines or a plurality of distinct computing stages or pipelines that may be capable of ingesting input of data from each detected body in a proper pose and in a parallel manner process predicted pose data, identity-recognition data (e.g., facial recognition data), and/or time-recording gesture or posture data since each virtual machine or the like may be capable of instantiating the plurality of distinct modules used for pose identification, identity-recognition, and/or time-recording recognition.

The instantiated instances of the pose detection model may function to receive a generated image of a respective body as input and, in turn, detect one or more body parts captured in the provided image of the respective body (e.g., head, hands, feet, hips, shoulders, and/or elbows, etc.) and/or determine positions of the one or more body parts detected in the provided image of the respective body (e.g., X, Y, and/or Z coordinates corresponding to each detected body part). In other words, in cases where the time recording data stream includes a plurality of bodies, S220 may function to generate dedicated images corresponding to each of the plurality of bodies identified in the time recording data stream and provide those generated images to distinct instances of a pose detection model. The distinct instances of the pose detection model, in turn, may detect which body parts may be present in the provided image of a subject body and/or determine X (distance), Y (height), and/or Z (depth) coordinates of the body parts detected in the provided image of the subject body.

### Time Recording Pose Criteria

In some embodiments, the computed X, Y, and/or Z coordinates for one or more body parts of a target body may be used, by S220, to assess whether the target body satisfies time recording pose criteria. In a first implementation, S220 may function to determine that the target body satisfies time recording pose criteria if a height (e.g., Y coordinate) of a first body part of the target body (e.g., hand) is above a height (e.g., Y coordinate) of at least a second body part of the target body (e.g., head and/or shoulders). Conversely, S220 may function to determine that the target body does not satisfy the time recording pose criteria if the height of the first body part of the target body is below the height of the second body part of the target body.

Additionally, or alternatively, in a second implementation, S220 may function to determine that the target body satisfies the time recording pose criteria if a distance between a third body part of the target body and a fourth body part of the target body (e.g., distance between an X-coordinate of the third body part and an X-coordinate of the fourth body part) is more than a threshold distance (e.g., 12 inches, 24 inches, 36 inches, etc.). Conversely, S220 may function to determine that the target body does not satisfy the time recording pose criteria if the distance between the third body part of the target body the fourth body part of the target body may not at least the threshold distance apart.

Additionally, or alternatively, in a third implementation, S220 may function to determine that the target body satisfies the time recording pose criteria if a first body part of the target body (e.g., hand) is above (or below) a second body part of the target body (e.g., shoulders) by at least a threshold amount (e.g., 12 inches, 24 inches, 36 inches, etc.). Conversely, S220 may function to determine that the target body does not satisfy the time recording pose criteria if the first body part of the target body (e.g., hand) is not above (or below) the second body part of the target body (e.g., shoulders) by at least the threshold amount (e.g., 12 inches, 24 inches, 36 inches, etc.).

It shall be recognized that the time recording pose criteria may be set in any suitable manner including, but not limited, criteria that set relative positioning requirements between distinct body parts of a target user for satisfying or defining a predetermined time recording pose.

In some embodiments, in cases where the time recording data stream includes a plurality of bodies, S220 may function to concurrently detect a pose for each of the plurality of bodies. Thus, in such embodiments, S220 may function to concurrently detect that a subset of the bodies in the time recording data stream satisfy the time recording pose criteria, that a subset of the bodies in the time recording data stream do satisfy the time recording pose criteria, that none the bodies in the time recording data stream satisfy the time recording pose criteria, and/or that all the bodies in the time recording data stream satisfy the time recording pose criteria.

When a respective body identified in the time recording data stream satisfies the time recording pose criteria, the automated electronic time recording service may recognize that the respective body may be intending to record time to the automated electronic time recording service. Conversely, if a respective body identified in the time recording data stream does not satisfy the time recording pose criteria, the automated electronic time recording service may recognize that the respective body may not be intending to record time to the automated electronic time recording service—thus minimizing the processing of unintended time recording transactions (e.g., minimizing the recording of unintended punch transactions to the automated electronic time recording service).

As will be described in more detail below, in some embodiments, in response to determining that one or more bodies in the time recording data stream satisfy the time recording pose criteria, S220 may function to extract probative portions from the one or more generated images of the one or more bodies (e.g., extract the heads of the one or more bodies, the hands of the one or more bodies, and/or the like) and forward those extracted probative portions to time recording recognition models.

### Body Location Detection

In a variant implementation, the computed X, Y, and/or Z coordinates for one or more body parts of a target body may be used, by S220, to determine a location of the target body within the time recording scene. In such embodiments, S220 may function to compare an X, Y, and/or Z location of a body part (e.g., foot) to known boundary (e.g., perimeter) coordinates of the time recording zones in the time recording scene. If S220 determines that the X, Y, and/or Z location of a body part exists within a respective time recording zone boundary, S220 may function to determine that the target body may be located within that respective time recording zone. For instance, in a nonlimiting example, S220 may function to determine that a target body may be located within a first time recording zone if an X, Y, and/or Z location of a foot of the target body exists within the X, Y, and/or Z boundary of the first time recording zone. Conversely, S220 may function to determine that the target body may be located within a second time recording zone if the X, Y, and/or Z location of the foot of the target body exists within the X, Y, and/or Z boundary of the second time recording zone. In some portions of the disclosure, the determination related to a target body's location within the time recording scene may be referred to as a “location signal.”

### 2.25 Dynamic Power Management

S225 dynamically adjusts device-level and processing-stage settings in response to detecting initiation of a time recording action in the time-recording data stream. These adjustments conserve energy during low-activity periods and provide increased processing fidelity during user interactions.

First processing setting (idle). Initially, one or more cameras operate at a first processing setting selected to conserve energy. The first setting may include a lower frame rate and/or lower resolution (e.g., about 10 fps or less and 640×480 or lower) suitable for coarse monitoring. Additionally, or alternatively, the system may hold the camera frame rate fixed while a time-recording data identification stage processes every nth frame (n≥2) at idle to reduce computational load.

Transition to second processing setting (active). Upon detecting initiation of a time-recording action, S225 transitions to a second processing setting that increases capture and analysis fidelity for the active interval. In some embodiments, the system performs one or more of: (i) increasing the camera frame rate; (ii) increasing the image resolution; (iii) decreasing n so that more frames are processed per unit time; (iv) transitioning from a lightweight model to a heavier model; (v) raising processor clock frequency and/or activating additional cores; and (vi) activating or increasing supplemental lighting. Elevating any of the foregoing settings facilitates more reliable body/pose detection (S220), identity recognition (S230), and gesture recognition (S240).

Compute scaling and model selection. In some embodiments, the adjustments of [0078] include one or both of: (a) transitioning from a lightweight model to a heavier model having a higher number of parameters; and (b) increasing computational capacity by raising processor clock frequency and/or activating additional cores. Either action may be taken independently of the other, and in some cases both are performed to meet latency or accuracy targets during the active interval.

Supplemental lighting. The system may activate or increase supplemental lighting to improve image quality during the active interval, and may return lighting to an off/low state when the active interval ends.

Maintain and revert. The system maintains the second processing setting for a timeout interval T and reverts to the first setting if no subsequent time-recording action is detected before T expires (e.g., about 5 minutes). Reversion may include one or more of: reducing camera frame rate/resolution, restoring n to its idle value, transitioning back to the lightweight model if a heavier model was in use, de-allocating additional compute, and dimming or turning off supplemental lighting. Detection of a further time-recording action during T resets T and extends the active interval. Values for fps, resolution, n, and T are exemplary and may be tuned per deployment.

Notes. The specific settings and durations above are illustrative, not limiting; other frame rates, resolutions, n values, illumination levels, and timeout intervals may be used as appropriate. This dynamic approach reduces average power during idle periods while preserving low latency and high recognition quality when user interactions occur.

### 2.30 User Identity Recognition

S230, which includes detecting an identity of one or more bodies, may function to identify or detect an identity of the one or more bodies captured/detected in the time recording data stream. It shall be noted that if S220 detected that one or more bodies in the time recording data stream did not satisfy the time recording pose criteria, S230 may not function to detect an identity for those one or more bodies. Alternatively, it shall also be noted that if S220 detected that a plurality of bodies in the time recording data stream satisfied the time recording pose criteria, S230 may function to concurrently (or simultaneously) detect an identity for each of those plurality of bodies—as opposed to sequentially detected.

In one or more embodiments, S230 may function to implement a facial recognition model (or user-recognition model) to compute an identity of a target body. In such embodiments, the facial recognition model may function to receive an image of a head of the target body as input and derive an identity of the target body as output, such as a name associated with the target body, an identification number associated with the target body (as described in S210), contact information associated with the target body, and/or the like. The output of the facial recognition model in some portions of the disclosure may be referred to herein as an “identification signal” and/or an identification inference. It shall be noted that in cases where the time recording data stream includes a plurality of bodies that satisfy the time recording pose criteria, S230 may function to instantiate a plurality of instances of the facial recognition model to concurrently compute an identity associated with the plurality of bodies.

The image of the head of the target body that may be provided to the facial recognition model may have been created based on or extracted from the image of the target body generated in S220. That is, in response to determining that the target body satisfied the time recording pose criteria, S230 may function to generate the image of the head of the target body by extracting pixels, from the generated image of the target body in S220, that correspond to the head of the target body.

Additionally, or alternatively, to the embodiment described above, the facial recognition model may function to receive an image of a head of the target body as input and produce a facial feature vector associated with the head of the target body as output. The facial feature vector may include one or more values corresponding to one or more facial features represented in the image of the head of the target body, such a computed value corresponding to the eyes of the target body, a computed value corresponding to the nose of the target body, a computed value corresponding to the ears of the target body, a computed value corresponding to the lips of the target body, a computed value corresponding to the chin of the target body, and/or the like. The facial feature vector computed for the target body may then be compared to a plurality of reference facial feature vectors that are digitally associated with a plurality of potential users of the automated electronic time recording service to determine an identity of the target body.

In some cases, the image of the head of the target body may not be of sufficient image quality or image resolution to allow the facial recognition model to accurately derive an identity of the target body. That is, the image of the head of the target body may have an insufficient number of pixels (e.g., less than a threshold number of pixels) to detect an identity of the target body. As a result, the facial recognition model may return an indication indicating a facial recognition matching failure (e.g., insufficient pixels in image, etc.) or an indication of no facial match based on the image of the head of the target body. When the facial recognition model returns such an indication, S230 may function to forgo executing the remaining steps of method 200 and transmit the time recording data stream identified in S220 (or at least a portion of the time recording data stream) to a predetermined entity to assess the time recording intent of the target body (e.g., administrator, human arbiter, etc.).

Conversely, in some embodiments, the facial recognition model may not be able to identify the target body even if the image of the head of the target body may be of sufficient quality. This may occur because a user associated with the target body has not been previously enrolled to the automatic electronic time recording system (as described in S210). Accordingly, in such cases, S230 may function to initiate a process to automatically enroll or automatically enroll—optionally with no additional user input—the user associated with the target body to the automatic time recording service in similar ways described in S210 based at least on the extracted image of the head of the target body.

It shall be noted that S230 may additionally, or alternatively, function to use other suitable biometric data including, but not limited to, voice biometric data, gait biometric data, and/or the like captured in the time recording data stream to an identify an identity of a target body (e.g., in analogous ways described above).

In a variant implementation, S230 may function to determine an identity of one or more target users within a time recording scene based on identifying and processing a computer-readable or computer-identifiable indicia positioned along a respective body (as extracted by S220). The computer-identifiable indicia may include any suitable indicia including, but not limited to, one or more characters (e.g., alphanumeric characters), an image (e.g., a drawing, cartoon character), readable code (e.g., QR code or the like), and the like. In a similar manner, as described herein, S230 may function to process the computer-identifiable indicia to identify an identity or identity account value of each of the one or more target users within the time recording scene.

### 2.40 Time Recording Gesture Recognition

S240, which includes detecting time recording gestures, may function to detect time recording gestures performed by the one or more bodies identified in the time recording data stream. In one or more embodiments, bodies in the time recording data stream may perform a time recording gesture to record (or indicate) a start of a new time recording activity to the automated electronic time recording service (e.g., started working, started lunch, started a break, and/or the like) and/or to record (or indicate) an end of an activity to the automated electronic time recording service (e.g., stopped working, finished lunch, finished the break, and/or the like). Additionally, or alternatively, bodies in the time recording data stream may perform non-explicit or general time recording gestures. As generally referred to herein, non-explicit or general time recording gestures may not indicate a specific time recording activity to which the time recording gesture corresponds, and thus requires the automated electronic time recording service or a time recording application in operable communication with the automated electronic time recording service (or system) to derive the associated time recording activity based on past time recording actions performed by that respective body.

In some embodiments, if S220 functioned to determine that a plurality of bodies detected in the time recording data stream satisfied the above-described time recording pose criteria, one or more functions of S240 may be performed, concurrently or contemporarily, for those plurality of bodies. Additionally, or alternatively, if S220 functioned to determine that one or more bodies detected in the time recording data stream did not satisfy the above-described time recording pose criteria, one or more functions of S240 may not be performed for those one or more bodies.

In one or more embodiments, S240 may function to implement a time recording gesture recognition algorithm to detect which time recording gesture a target body performed. In such embodiments, the time recording gesture recognition algorithm may function to receive an image of a hand of the target body as input (or an image of another body part) and provide a name of the corresponding performed time recording gesture as output. It shall be noted that the time recording gesture recognition algorithm or model may be able to detect single-part time recording gestures and/or multi-part time recording gestures, as will be described in more detail herein.

Additionally, or alternatively, to the embodiment described above, the time recording gesture recognition algorithm may function to receive an image of the hand of the target body as input and produce a hand pose estimation vector associated with the hand of the target body as output. The hand pose estimation vector may include one or more values that indicate the pose of the hand of the target body. The hand pose estimation vector computed for the target body may then be compared to a plurality of reference hand pose vectors digitally associated with a time recording code/action (e.g., clock-in, clock-out, etc.) to determine the time recording activity performed by the hand of the target body.

In some embodiments, the input provided to the time recording gesture recognition algorithm or model may correspond to the portion of the target body that satisfied the time recording pose criteria. For instance, in a non-limiting example, if the target body satisfied time recording pose criteria because a first (e.g., right) hand of the target body was located above one or more shoulders of the target body, S240 may function to provide an image of the first (e.g., right) hand of the target body to the time recording gesture recognition algorithm. Conversely, in a second non-limiting example, if the target body satisfied the time recording pose criteria because a second (e.g., left) hand of the target body was located above one or more shoulders of the target user, S240 may function to provide an image of the second (e.g., left) hand of the target body to the time recording gesture recognition algorithm.

The image provided to the time recording gesture recognition algorithm may have been extracted (or cropped) from the image generated for the target body in S220. That is, in response to determining that a target body satisfied the time recording pose criteria, S240 may function to generate the image of the hand of the target body by extracting pixels, from the generated image of the target body in S220, that correspond to the hand of the target body that caused the time recording pose criteria to be satisfied.

After providing the image of the hand of the target body as input to the time recording gesture recognition algorithm, the time recording gesture recognition algorithm may compute an identifier or the name of the performed time recording gesture (or a time recording code) as output. For instance, in a non-limiting example, if the image of the hand of the target body indicates a first hand pose (e.g., all the fingers of the hand are curled towards the palm of the hand), the time recording gesture recognition algorithm may compute that the image of the hand of the target body corresponds to a first time recording gesture or activity (e.g., clock-in gesture). Conversely, if the image of the hand of the target body indicates a second hand pose (e.g., all the fingers of the hand are extended away from the palm of the hand), the time recording gesture recognition algorithm may compute that the image of the hand of the target body corresponds to a second time recording gesture or activity (e.g., clock-out gesture). It should be understood that the image of the hand of the target body may correspond to a plurality of possible handshapes, and thus correspond to a plurality of possible distinct time recording gestures. It shall be recognized that the time recording gesture recognition algorithm may function to compute a time recording code, which may be one of a plurality of distinct time recording codes of the time recording system and/or service. In such embodiments, each of the plurality of distinct time recording codes may be mapped to or electronically associated with one distinct electronic time recording action of a plurality of distinct time recording actions (e.g., clock-in, clock-out, transfer, meal break, and/or the like).

Additionally, or alternatively, the time recording recognition algorithm may function to detect multi-part time recognition gestures. Multi-part time recognition gestures may be gestures that contain multiple parts or portions that must be performed in succession of each other within a threshold amount of time (e.g., 5, 10, 15, 20, 25, 30, 60, 90, and/or like seconds). For instance, in a non-limiting example, a first multi-part time recognition gesture may require that two distinct “closed” fist hand poses be detected within the threshold amount of time. Similarly, a second multi-part time recognition gesture may require that n-number of distinct hand poses be detected within the threshold amount of time.

Accordingly, in such embodiments, S240 may function to receive, from S220, images of the target body over different frames in the time recording data stream—preferably frames in the time recording data stream where the target user was satisfying the time recording pose criteria. In response to receiving the images of the target body, S240 may function to extract the hand of the target body that satisfied the time recording pose criteria from each of the plurality of images and generate a chronologically ordered “gesture sequence” image that includes the extracted hand from each of the of the plurality of images. This gesture sequence image may then be provided to the time recording gesture recognition algorithm to predict the time recording gesture or action performed by the target body.

In some cases, the image of the hand of the target body may not be of sufficient image quality or image resolution to allow the time recording gesture recognition algorithm to accurately detect which time recording gesture the target body performed. In such embodiments, the time recording gesture recognition algorithm may return an indication indicating a time recording gesture recognition failure (e.g., insufficient pixels in image, etc.). When the time recording gesture recognition algorithm returns such an indication, S240 may function to forgo executing the remaining steps of method 200 and transmit the time recording data stream identified in S220 (or at least a portion of the time recording data stream) to a predetermined entity (e.g., administrator, human arbiter, etc.) to assess the time recording intent of the target body.

Conversely, in some embodiments, the time recording gesture recognition model may not be able to identify the performed time recording gesture even if the image of the gesture-performing body part of the target body may be of sufficient quality or even if a calculated confidence or inference probability satisfies a gesture-recognition threshold (e.g., a minimum confidence or inference probability value). This may occur because the target body performed a non-explicit or general time recording gesture, as described previously. In such embodiments, the time recording gesture recognition algorithm may return an indication that the target body performed an implicit time recording gesture. In a variant implementation, S240 may function to route the image of the gesture-performing body part of the target body to a time recording review queue. In such variant implementation, if an identity of the target body may be known or discoverable, S240 may function to route the gesture-performing body part together with a target body user identifier to a review queue user interface for an enhanced review or assessment and a calculated disposal of the intended time recording action.

It shall be noted that the output of the time recording gesture recognition algorithm in some portions of the disclosure may be referred to herein as a “time recording gesture signal” and/or a “time recording action inference.”

### 2.50 Time Recording

S250, which includes automated electronic time recording, may function to compute an intended time recording action for one or more target bodies. Additionally, or alternatively, S250 may function to transmit confirmation or verification time recording notifications to the users associated with the one or more target bodies. It shall be noted that, in embodiments where S220 detected that a plurality of bodies in the time recording data stream satisfied the time recording pose criteria, S250 may function to compute an intended time recording action for each of the plurality of bodies in parallel (as opposed to sequentially computing the intended time recording action for each of the plurality of bodies).

In some embodiments, S250 may function to determine an intended time recording action for a target body based on a corresponding user identification (e.g., employee identifier) signal computed for the target body, a corresponding time recording gesture signal computed for the target body, and/or a corresponding location signal computed for the target body. That is, for a first target body, S250 may function to compute or derive the intended time recording action corresponding to the first target body based on the identification signal computed for the first target body, a time recording gesture signal computed for the first target body, and/or a location signal computed for the first target body. Conversely, for a second target body, S250 may function to compute the intended time recording action corresponding to the second target body based on an identification signal computed for the second target body, a time recording gesture signal computed for the second target body, and/or a location signal computed for the second target body (e.g., different signals as compared to the signals used to compute the intended time recording action of the first target body).

In one or more embodiments, computing or deriving the time recording action may include receiving a distinct time recording signal in association with a unique user account or user identifier value (signal). In such embodiments, if the time recording signal comprises a time recording code or the like, S250 may function to perform a time recording action lookup or search using the code. In one example, the method 200 may implement and/or access one or more data structures, such as code lookup tables, that S250 may function to access via a lookup or search with a given time recording code to identify an appropriation time recording action or time recording entry.

In some embodiments, the time recording activity performed by the target body may be registered as an entry into a time recording database of the automated electronic time recording service (or registered as an entry into a time recording database communicatively coupled with the automated electronic time recording service). To register the time recording activity performed by the target body as an entry into the time recording database, electronic ledger, or electronic journal, the entry may require one or more of the following to be specified: (1) an ID associated with the target body that performed the time recording activity, (2) the job task associated with the time recording activity, (3) the time recording activity type corresponding to the time recording activity, and/or (4) a time stamp (e.g., a date/time of time recording activity) and in some embodiments, a time stamp location identifier (e.g., timeclock identifier). Additionally, or alternatively, the time recording entry may be posted or recorded to an account associated with a distinct user or employee user. In such embodiments, the account of the user may include one or more electronic media dedicated to the user account for recording time recording activities or entries.

S250 may additionally or alternatively function to store a copy of the image of time recording gesture and/or a copy of the image of the body segment used for identification in association with the time recording entry. In this way, a confirmation or validation (including electronic auditing) may be performed for each time recording entry to ensure a technical accuracy of the gesture recognition model and user identification recognition model.

In a preferred embodiment, the ID associated with the target body that is specified in the above-described entry may correspond to the User ID indicated in the identification signal computed for the target body (as described in S230). This may, if the identification signal computed for the target body indicates a first User ID, the User ID specified in the above-described database entry may be the first User ID. Conversely, if the identification signal computed for the target body indicates a second User ID, the User ID specified in the above-described database entry may be the second User ID.

Additionally, or alternatively, in a preferred embodiment, the job task that is specified in the above-described entry may be based on the location signal computed for the target body. The location signal, as previously described in S220, may indicate the time recording zone in which the target body may be located. Accordingly, if the location signal computed for the target body indicates that the target body is located within a first time recording zone, the job task specified in the above-described database entry may be the job task that corresponds to the first time recording zone (e.g., a first job task). Conversely, if the location signal computed for the target body indicates that the target body is located within a second time recording zone, the job task specified in the above-described database entry may be the job task that corresponds to the second time recording zone (e.g., a second job task). It shall be noted that, in some embodiments, a job task does not need to be provided in order to record a time recording activity to the time recording database.

Additionally, or alternatively, in a preferred embodiment, the time recording activity type that is specified in the above-described entry may be based on the time recording gesture signal computed for the target body. The time recording gesture signal, as previously described in S240, may indicate the time recording gesture performed by the target body. Accordingly, if the time recording gesture signal computed for the target body indicates that the target body performed a first time recording gesture, the time recording activity type specified in the above-described database entry may be the time recording activity type that corresponds to the first time recording gesture (e.g., clock-in if the first time recording gesture corresponds to a clock-in gesture). Conversely, if the time recording gesture signal computed for the target body indicates that the target body performed a second time recording gesture, the time recording activity type specified in the above-described database entry may be the time recording activity type that corresponds to the second time recording gesture (e.g., clock-out if the second time recording gesture corresponds to a clock-out gesture). It shall be noted that S250 may function to (e.g., concurrently) register, to the time recording database, time recording activities of other users in the time recording data stream in similar ways described above.

In some embodiments, a time recording state (e.g., punch state) of the user account associated with the target body may be modified/updated in response to S250 registering a new time recording activity for the target body to time recording database. For instance, before the above-described time recording activity was registered to the time recording database, the user account associated with the target body may have been in a first time recording state (e.g., clocked-in state), and after registering the above-described time recording activity to the time recording database, the time recording state of the user account associated with the target user may have been updated from the first time recording state (e.g., clocked-in state) to a second time recording state (e.g., clocked-out state).

Additionally, in some embodiments, in response to registering a time recording activity performed by a target body to a time recording database, S250 may function to display, via a display generation component of the automated-electronic time recording service, a notification (or indication) that indicates the time recording activity performed by the target body was successfully registered to the time recording database and/or that indicates information relating to the time recording activity. Additionally, or alternatively, in some embodiments, S250 may function to transmit, to an electronic device associated with the user account that corresponds to the target body, a notification (or indication) that indicates the time recording activity performed by the target body was successfully registered to the time recording database and/or that indicates information relating to the time recording activity.

In some embodiments, if an incorrect time recording activity was registered to the time recording database (e.g., the time recording activity computed by S250 differed from the intended time recording activity of the target body), an administrator (or another entity) of the automated electronic time recording service may update the entry in the time recording database corresponding to the time recording activity to reflect the time recording activity intended by the target body and/or trigger model retraining to minimize the automated electronic time recording service from repeating the same computation error in the future (e.g., trigger retraining of the one or more models/algorithms described above).

### 3. Computer-Implemented Method and Computer Program Product

The system and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processors and/or the controllers. The computer-readable medium can be stored on any suitable computer readable media such as RAMs, ROMs, flash memory, EEPROMs, optical devices (CD or DVD), hard drives, floppy drives, or any suitable device. The computer-executable component may preferably a general or application specific processor, but any suitable dedicated hardware or hardware/firmware combination device can alternatively or additionally execute the instructions.

Although omitted for conciseness, the preferred embodiments include every combination and permutation of the implementations of the systems and methods described herein.

As a person skilled in the art will recognize from the previous detailed description and from the figures and claims, modifications and changes can be made to the preferred embodiments of the invention without departing from the scope of this invention defined in the following claims.

We claim:

1. A method of operating a time recording system while monitoring a time recording space, the method comprising:
(a) obtaining, by one or more cameras, a video stream from the time recording space;
(b) processing, by one or more processors, the video stream at a first processing setting that comprises one or more of: (i) operating at a first frame rate, (ii) processing every nth frame of the video stream where n is greater than or equal to two, and (iii) operating at a first image resolution;
(c) detecting initiation of a time recording action performed by a user based on body-pose or gesture criteria;
(d) in response to detecting the initiation, adjusting the system to a second processing setting by performing one or more of: (i) increasing the frame rate, (ii) decreasing n to increase a number of frames processed per unit time, (iii) increasing the image resolution, (iv) increasing computational capacity by raising a processor clock frequency and/or activating additional processor cores, and (v) activating or increasing supplemental lighting directed to the time recording space;
(e) maintaining the second processing setting for a timeout interval T; and
(f) reverting to the first processing setting if no further time recording action is detected before expiration of T.

2. The method of claim 1, wherein detecting the initiation comprises determining that a hand of the user is positioned at least a threshold vertical distance above a shoulder of the user.

3. The method of claim 1, wherein the first processing setting comprises one or more of: (i) a frame rate of about ten frames per second or less, (ii) processing every nth frame with n greater than or equal to four, and (iii) an image resolution of 640×480 pixels or lower.

4. The method of claim 1, wherein the second processing setting comprises one or more of: (i) a frame rate between 15 and 60 frames per second, (ii) processing every nth frame with n less than or equal to two, and (iii) an image resolution of 1280×720 pixels or higher.

5. The method of claim 1, wherein generic scene motion alone does not trigger the second processing setting, and the adjustment of step (d) occurs in response to detecting initiation of the time recording action.

6. The method of claim 1, wherein increasing computational capacity of step (d)(iv) comprises one or more of: (i) raising a CPU and/or GPU clock frequency using dynamic voltage and frequency scaling, and (ii) activating one or more additional processor cores.

7. The method of claim 1, further comprising analyzing the video stream at the first processing setting using a first machine-learning model and, during the second processing setting, analyzing using a second machine-learning model having a greater number of parameters than the first machine-learning model.

8. The method of claim 1, wherein maintaining the second processing setting comprises starting the timeout interval T upon the detecting and resetting T upon detection of a subsequent time recording action.

9. The method of claim 1, wherein the camera operates at a constant frame rate at both the first and second processing settings, and decreasing n increases a number of frames processed per unit time.

10. The method of claim 1, wherein at least a portion of detecting the initiation and adjusting to the second processing setting is performed by a remote server in a cloud computing environment, and device-level commands to the camera and/or lighting are transmitted over a wide-area network.

11. The method of claim 1, wherein increasing computational capacity comprises raising a processor clock frequency using dynamic voltage and frequency scaling.

12. A time recording system comprising:
one or more cameras configured to acquire a video stream of a time recording space;
one or more processors; and
memory storing instructions that, when executed by the one or more processors, cause the system to:
(i) process the video stream at a first processing setting that comprises one or more of: operating at a first frame rate, processing every nth frame where n is greater than or equal to two, and operating at a first image resolution;
(ii) detect initiation of a time recording action performed by a user based on body-pose or gesture criteria;
(iii) in response to detecting the initiation, adjust the system to a second processing setting by performing one or more of: (A) increasing the frame rate, (B) decreasing n to increase a number of frames processed per unit time, (C) increasing the image resolution, (D) increasing computational capacity by raising a processor clock frequency and/or activating additional processor cores, and (E) activating or increasing supplemental lighting directed to the time recording space;
(iv) maintain the second processing setting for a timeout interval T; and
(v) revert to the first processing setting if no further time recording action is detected before expiration of T.

13. The system of claim 12, wherein processing at the first processing setting comprises processing every nth frame with n greater than or equal to two, and wherein adjusting to the second processing setting comprises decreasing n.

14. The system of claim 12, wherein the first processing setting comprises one or more of: (i) a frame rate of about ten frames per second or less and (ii) an image resolution of 640×480 pixels or lower, and wherein the second processing setting comprises one or more of: (iii) a frame rate between 15 and 60 frames per second and (iv) an image resolution of 1280×720 pixels or higher.

15. The system of claim 12, further comprising a lighting module configured to activate or increase illumination during the second processing setting and reduce illumination or turn off upon reversion to the first processing setting.

16. The system of claim 12, wherein the instructions are further configured to switch from a first machine-learning model used at the first processing setting to a second machine-learning model having a greater number of parameters used at the second processing setting.

17. The system of claim 12, wherein the processors comprise a GPU or hardware accelerator, and the instructions are configured to offload inference to the GPU or hardware accelerator during the second processing setting.

18. The system of claim 12, further comprising a device-control interface configured to carry device-control commands to at least one of: the one or more cameras and the lighting module, the device-control interface comprising at least one of a wired control bus and a wireless control channel.

19. The system of claim 12, wherein at least a portion of the one or more processors are hosted in a cloud computing environment, and the system is configured to transmit device-level commands over a wide-area network to at least one of: (i) a scene-capturing device to configure frame rate and/or resolution; and (ii) a lighting control module to activate or adjust supplemental lighting.

20. A non-transitory computer-readable medium storing instructions that, when executed by one or more processors of a time recording system, cause the system to perform operations comprising:
(a) obtaining, by one or more cameras, a video stream from a time recording space;
(b) processing the video stream at a first processing setting that comprises one or more of: operating at a first frame rate, processing every nth frame where n is greater than or equal to two, and operating at a first image resolution;
(c) detecting initiation of a time recording action performed by a user based on body-pose or gesture criteria;
(d) in response to detecting the initiation, adjusting the system to a second processing setting by performing one or more of: (i) increasing the frame rate, (ii) decreasing n to increase a number of frames processed per unit time, (iii) increasing the image resolution, (iv) increasing computational capacity by raising a processor clock frequency and/or activating additional processor cores, and (v) activating or increasing supplemental lighting directed to the time recording space;
(e) maintaining the second processing setting for a timeout interval T; and
(f) reverting to the first processing setting if no further time recording action is detected before expiration of T.
